(19) United States
(12) Patent Application Publication
(10) Pub. No.: US 2015/0379251 A1
(43) Pub. Date: Dec. 31, 2015

(54) ELECTRONIC DEVICE, METHOD, AND COMPUTER PROGRAM PRODUCT

(71) Applicant: Kabushiki Kaisha Toshiba, Tokyo (JP)

(72) Inventor: Hiroaki KOMAKI, Tachikawa Tokyo (JP)

(21) Appl. No.: 14/566,372

(22) Filed: Dec. 10, 2014

(30) Foreign Application Priority Data
Jun. 27, 2014 (JP) 2014-133179

(51) Int. Cl. G06F 21/32; G06K 9/00

(52) U.S. Cl. CPC G06F 21/32; G06K 9/00013; G06K 9/00087

(57) ABSTRACT

According to one embodiment, an electronic device including: a fingerprint detector; and circuitry configured to execute a first function when a detected fingerprint substantially coincides with a first fingerprint from a plurality of registered fingerprints of a user, and to execute a second function different from the first function when a detected fingerprint substantially coincides with a second fingerprint different from the first fingerprint from a plurality of registered fingerprints of the user.

### CROSS-REFERENCE TO RELATED APPLICATIONS

This application is based upon and claims the benefit of priority from Japanese Patent Application No. 2014-133179, filed Jun. 27, 2014, the entire contents of which are incorporated herein by reference.

### FIELD

Embodiments of the present invention relate to an electronic device, a method, and a computer program product.

### BACKGROUND

There is a wearable terminal having a plurality of functions such as a function of notifying an event that has occurred in a smart phone, and a function of detecting biological information such as user's activity information and sleep state (such as, for example, sleeping hours and depth of sleep) by using an acceleration sensor or the like.

By the way, the wearable terminal is required to mount a personal authentication function with the object of expanding application use and protecting user information. Furthermore, due to characteristics of the wearable terminal that the wearable terminal is worn daily by the user, reduction of the size and weight of the casing of the wearable terminal is demanded.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a diagram illustrating an exterior view of a wearable terminal according to a first embodiment;

FIG. 2 is a block diagram illustrating a hardware configuration of the wearable terminal according to the first embodiment;

FIG. 3 is a diagram for explaining registration processing of a fingerprint conducted by the wearable terminal according to the first embodiment;

FIG. 4 is a diagram for explaining execution processing of various functions conducted by the wearable terminal according to the first embodiment;

FIG. 5 is a flow chart illustrating a flow of the registration processing of a fingerprint conducted by the wearable terminal according to the first embodiment;

FIG. 6 is a flow chart illustrating a flow of execution processing of a corresponding function conducted by the wearable terminal according to the first embodiment;

FIG. 7 is a flow chart illustrating a flow of setting processing of a corresponding function conducted by a wearable terminal according to a second embodiment; and

FIG. 8 is a flow chart illustrating a flow of execution processing of a function conducted by a wearable terminal according to a third embodiment.

### DETAILED DESCRIPTION

In general, according to one embodiment, an electronic device comprising: a fingerprint detector; and circuitry configured to execute a first function when a detected fingerprint substantially coincides with a first fingerprint from a plurality of registered fingerprints of a user, and to execute a second function different from the first function when a detected fingerprint substantially coincides with a second fingerprint different from the first fingerprint from a plurality of registered fingerprints of the user.

Hereafter, a wearable terminal to which an electronic device, a method, and a computer program product according to the present embodiments are applied, will be described with reference to the accompanying drawings.

### First Embodiment

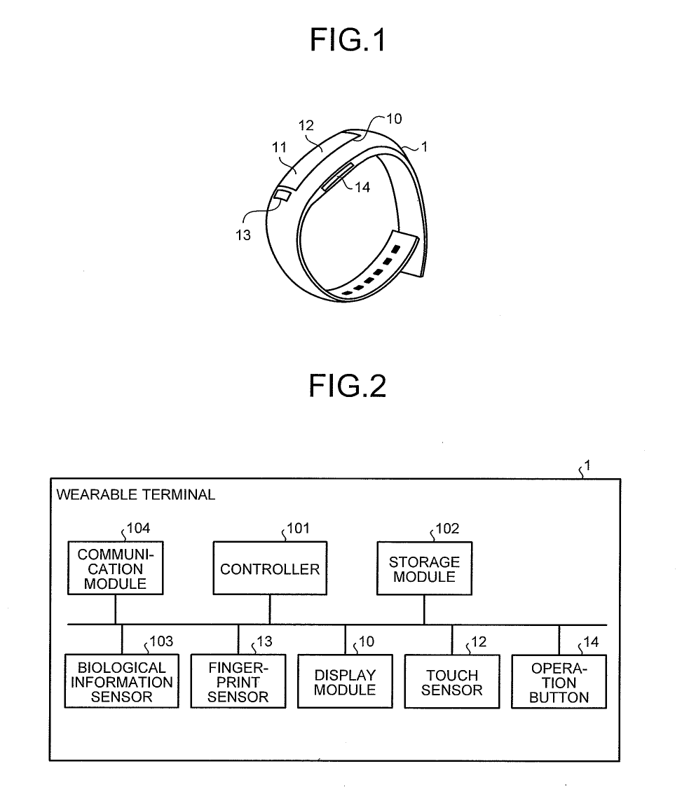

FIG. 1 is a diagram illustrating an exterior view of a wearable terminal according to a first embodiment. As illustrated in FIG. 1, a wearable terminal 1 according to the first embodiment is an example of an electronic device that can be worn on a portion of a user's body. Furthermore, the wearable terminal 1 can detect biological information (such as, for example, activity quantities such as the number of steps and consumed calories, body temperature, sweating, pulsation, and sleep depth) of a user who wears the wearable terminal 1. In the first embodiment, the sleep depth indicates which of states: awakening that the user stays awake, shallow sleep, and deep sleep.

Furthermore, as illustrated in FIG. 1, the wearable terminal 1 comprises a display module 10 having a display screen 11 (such as, for example, a liquid crystal display (LCD) or an organic electro luminescence (EL) display which is an example of a screen capable of displaying various kinds of information such as a detection result of user's biological information, a touch sensor 12 capable of detecting a touch position which is a position of touch operation on the display screen 11 in the display module 10, a fingerprint sensor 13 which is an example of a detection module capable of detecting a user's fingerprint, and an operation button 14 provided on a side face of a main body of the wearable terminal 1 and capable of inputting various operations to the wearable terminal 1. In other words, in the first embodiment, the display module 10 and the touch sensor 12 function as a so-called touch panel display.

A hardware configuration of the wearable terminal 1 according to the first embodiment will now be described with reference to FIG. 2. FIG. 2 is a block diagram illustrating a hardware configuration of the wearable terminal according to the first embodiment.

As illustrated in FIG. 2, the wearable terminal 1 according to the first embodiment comprises a controller 101, a storage module 102, a biological information sensor 103, and a communication module 104 besides the display module 10, the touch sensor 12, the fingerprint sensor 13, and the operation button 14 described with reference to FIG. 1.

The controller 101 comprises a central processing unit (CPU) or the like. The controller 101 controls respective modules comprised in the wearable terminal 1 by executing a program stored in the storage module 102 which will be described later. In the first embodiment, in a case where a fingerprint detected by the fingerprint sensor 13 coincides with a first fingerprint which is one fingerprint among a plurality of previously registered fingerprints, the controller 101 (an example of a control module) executes a first function which is a function corresponding to the first fingerprint. On the other hand, in a case where the fingerprint detected by the fingerprint sensor 13 coincides with a second fingerprint different from the first fingerprint among a plurality of previously registered fingerprints, the controller 101 executes a second function corresponding to the second fingerprint and different from the first function. As a result, the fingerprint sensor 13 added as the personal authentication function can be used as means to order execution of a function the wearable terminal 1 has. Further, an operation module such as several buttons that the wearable terminal 1 comprises can be reduced. Accordingly, the size and weight of the wearable terminal 1 comprising the fingerprint sensor 13 can be reduced.

The storage module 102 comprises a read only memory (ROM), a random access memory (RAM) or the like. The storage module 102 is capable of storing various kinds of information such as programs executed by the controller 101 and data used by the controller 101 when executing a program.

The biological information sensor 103 is capable of detecting biological information (such as, for example, activity quantities, body temperature, sweating, pulsation, and sleep depth) of a user who wears the wearable terminal 1. The communication module 104 is capable of communicating with an external device such as a smart phone by wireless communication.

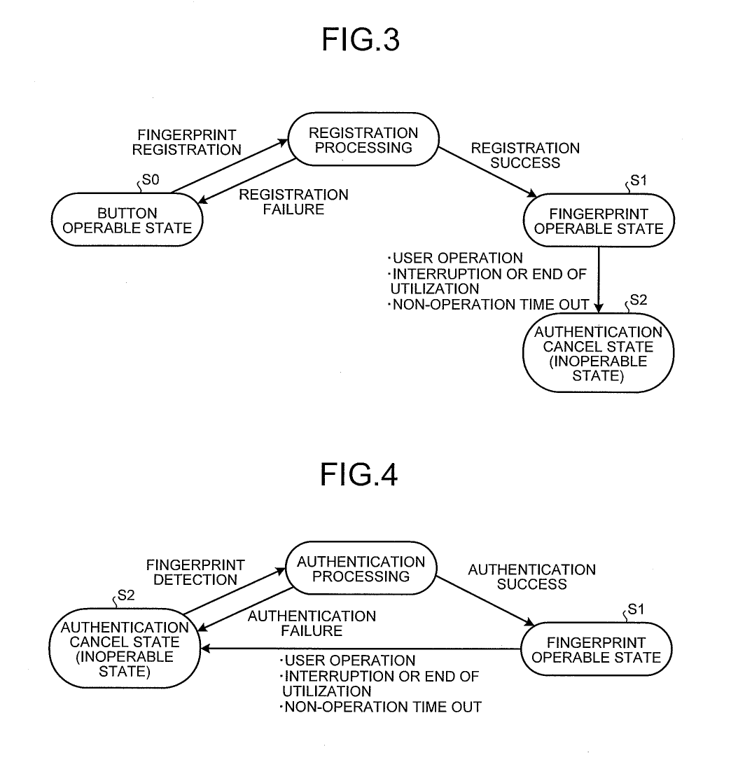

Fingerprint registration processing and execution processing of various functions conducted by the wearable terminal 1 according to the first embodiment will now be described with reference to FIG. 3. FIG. 3 is a diagram for explaining registration processing of a fingerprint conducted by the wearable terminal according to the first embodiment.

If a power supply of the wearable terminal 1 is turned on by operating the operation button 14 or the like in a state in which a fingerprint is not registered, the controller 101 in the first embodiment is brought into a button operable state S0 in which execution of a function depending upon operation of the operation button 14 is permitted (in other words, a state in which execution of a function corresponding to a fingerprint that coincides with a fingerprint detected by the fingerprint sensor 13 among previously registered fingerprints is inhibited (or restricted)). In the first embodiment, “execution of functions is restricted” means that execution of at least functions of a part among functions respectively corresponding to a plurality of previously registered fingerprints is inhibited. Upon shifting into the button operable state S0, the controller 101 starts registration processing of fingerprints corresponding to a registered fingerprint number n previously set(in the first embodiment, the registered fingerprint number n which is received from an external device such as a smart phone).

In the first embodiment, the controller 101 causes the storage module 102 to store a fingerprint detected by the fingerprint sensor 13 after the shift to the button operable state S0, and thereby executes registration processing of the detected fingerprint. The controller 101 repeats registration processing of a fingerprint detected by the fingerprint sensor 13 until registration processing of fingerprints corresponding to the registered fingerprint number n is conducted. At that time, the controller 101 sets one of corresponding functions which are predetermined functions that can be set for a fingerprint subjected to execution of registration processing among a plurality of functions that can be executed in the wearable terminal 1, as a function corresponding to the fingerprint subjected to execution of registration processing. In the first embodiment, the controller 101 causes the storage module 102 to store function information that indicates corresponding function set for the fingerprint, in association with the fingerprint subjected to execution of the registration processing.

In a case where before the registration processing of fingerprints corresponding to the registered fingerprint number n is conducted, a predetermined time has elapsed without detection of a new fingerprint since a last fingerprint is detected by the fingerprint sensor 13, the controller 101 judges that fingerprint registration has failed and erases fingerprints already stored in the storage module 102. On the other hand, in a case where the registration processing of fingerprints corresponding to the registered fingerprint number n is executed, the controller 101 judges that fingerprint registration has succeeded and shifts to a fingerprint operable state S1 in which a corresponding function corresponding to a fingerprint detected by the fingerprint sensor 13 can be executed.

Upon shifting to the fingerprint operable state S1, the controller 101 executes a corresponding function (such as, for example, a display function of various kinds of information on the display screen 11 in the display module 10, a function of interrupting utilization (operation) of the wearable terminal 1, a function of finishing utilization (operation) of the wearable terminal 1, a function of transmitting various commands to an external device such as a smart phone) which is an example of the first function or the second function corresponding to a fingerprint that coincides with the fingerprint detected by the fingerprint sensor 13 among a plurality of fingerprints subjected to execution of registration processing, in addition to execution of a function depending upon user's operation using the operation button 14.

Furthermore, in a case where after the shift to the fingerprint operable state S1, a state in which a fingerprint is not detected by the fingerprint sensor 13 continues for a predetermined time and the fingerprint operable state S1 times out (hereafter referred to as non-operation time out), the controller 101 shifts to an authentication cancel state S2 (in other words, an inoperable state) in which execution of a corresponding function corresponding to a fingerprint detected by the fingerprint sensor 13 is inhibited (or restricted). In the authentication cancel state S2, the controller 101 inhibits execution of a function depending upon operation using the operation button 14 and a corresponding function corresponding to a fingerprint detected by the fingerprint sensor 13. As a result, after the execution of a corresponding function is caused by using the fingerprint sensor 13 since the shift to the fingerprint operable state S1, it is possible to automatic shift to the authentication cancel state S2. Accordingly, convenience of the wearable terminal 1 can be improved, and it is possible to prevent a corresponding function from being executed in a case where the fingerprint sensor 13 is touched without an intention.

Execution processing of various functions conducted by the wearable terminal 1 according to the first embodiment will now be described with reference to FIG. 4. FIG. 4 is a diagram for explaining execution processing of various functions conducted by the wearable terminal according to the first embodiment.

In the first embodiment, the controller 101 is brought into the authentication cancel state S2 when the operation button 14 is operated and the power supply of the wearable terminal 1 is turned on in a state in which a fingerprint is already registered. When a fingerprint is detected by the fingerprint sensor 13 thereafter, the controller 101 executes authentication processing of a user by using the detected fingerprint. In the first embodiment, the controller 101 executes the authentication processing of the user on the basis of whether the detected fingerprint coincides with one of a plurality of fingerprints subjected to execution of the registration processing.

In the first embodiment, the controller 101 executes the authentication processing of the user on the basis of whether the fingerprint detected by the fingerprint sensor 13 coincides with one of a plurality of fingerprints subjected to execution of the registration processing. However, the first embodiment is not restricted to this as long as authentication processing of the user is executed by using a fingerprint detected by the fingerprint sensor 13. For example, the controller 101 may execute authentication processing of the user on the basis of whether the fingerprint detected by the fingerprint sensor 13 coincides with a fingerprint received from an external device such as a smart phone.

In a case where authentication processing of the user is not conducted, or a case where the fingerprint detected by the fingerprint sensor 13 does not coincide with any of a plurality of fingerprints subjected to execution of the registration processing, resulting in failed authentication processing of the user, the controller 101 maintains the authentication cancel state S2. In the case where the authentication processing of the user is not conducted or the case where the authentication processing of the user has failed, therefore, the fingerprint sensor 13 cannot be used as means to order execution of a function the wearable terminal 1 has. As a result, it is possible to prevent another person from operating the wearable terminal 1 by using the fingerprint sensor 13.

On the other hand, in a case where the fingerprint detected by the fingerprint sensor 13 coincides with one of a plurality of fingerprints subjected to execution of the registration processing, resulting in success of the authentication processing of the user, the controller 101 shifts to the fingerprint operable state S1. In other words, in a case where the authentication processing of the user has succeeded, the controller 101 executes a corresponding function corresponding to a fingerprint that coincides with the fingerprint detected by the fingerprint sensor 13 among a plurality of fingerprints subjected to execution of the registration processing, in the wake of the authentication processing of the user.

In a case where non-operation time out is caused after a shift to the fingerprint operable state S1 is conducted, the controller 101 causes a shift to the authentication cancel state S2 in which execution of a function corresponding to the fingerprint detected by the fingerprint sensor 13 is inhibited, again.

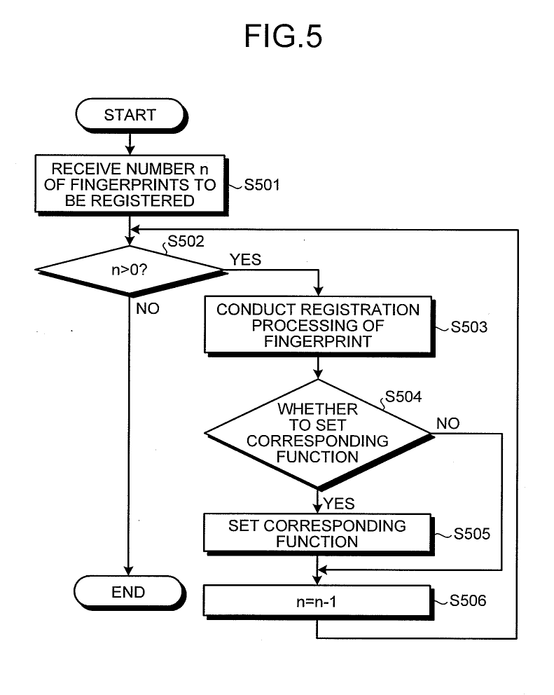

A flow of the registration processing of a fingerprint conducted by the wearable terminal 1 according to the first embodiment will now be described with reference to FIG. 5. FIG. 5 is a flow chart illustrating a flow of the registration processing of a fingerprint conducted by the wearable terminal according to the first embodiment.

If in a state in which a fingerprint is not registered, the operation button 14 is operated and the power supply of the wearable terminal 1 is turned on, the controller 101 shifts to the button operable state S0 and receives the registered fingerprint number n which is transmitted from an external device such as a smart phone via the communication module 104 (step S501). In addition, the controller 101 starts registration processing of fingerprints corresponding to the received registered fingerprint number n. In the first embodiment, the controller 101 receives the registered fingerprint number n from an external device such as a smart phone. However, the first embodiment is not limited to this. For example, the registered fingerprint number n may be input from the operation button 14, and the registration processing of fingerprints corresponding to the input registered fingerprint number n may be conducted.

With respect to executing registration processing of one fingerprint detected by the fingerprint sensor 13, the controller 101 determines whether the registered fingerprint number n is greater than “0” (step S502). In a case where the registered fingerprint number n is greater than “0” (step S502: Yes), the controller 101 executes registration processing of a fingerprint detected by the fingerprint sensor 13 (step S503). Subsequently, the controller 101 determines whether to set a corresponding function for the fingerprint subjected to execution of the registration processing (step S504). With respect to executing registration processing of one fingerprint, in the first embodiment, the controller 101 causes the display screen 11 in the display module 10 to display an order image to order whether to set a corresponding function for the fingerprint subjected to execution of the registration processing. In the first embodiment, the controller 101 causes the display screen 11 comprised in the wearable terminal 1 to display the order image. However, the controller 101 may cause a display module in an external device such as a smart phone to display the order image.

In a case where an order to set a corresponding function is given by using the order image (step S504: Yes), the controller 101 sets a corresponding function for the fingerprint subjected to execution of the registration processing (step S505). At that time, the controller 101 sets a different corresponding function for each fingerprint subjected to execution of the registration processing. For example, the controller 101 sets one of a plurality of corresponding functions in an ascending order of the order in which each of corresponding functions is set in advance, as a corresponding function of the fingerprint subjected to execution of the registration processing. Alternatively, the controller 101 may cause the display screen 11 (or a display module comprised in an external device such as a smart phone) to display a selection image to conduct selection from a plurality of corresponding functions and set a corresponding function selected by using the selection image, as a corresponding function for a fingerprint subjected to execution of the registration processing. At that time, the controller 101 inhibits selection of corresponding functions comprised in a plurality of corresponding functions and already set for fingerprints subjected to execution of the registration processing. As a result, the controller 101 sets different corresponding functions respectively for a plurality of fingerprints subjected to execution of the registration processing, as corresponding functions respectively for a plurality of fingerprints subjected to execution of the registration processing.

Then, in a case where an order to set a corresponding function is not given by using the order image (step S504: No), or after a corresponding function is set for a fingerprint subjected to execution of the registration processing (step S505), the controller 101 subtracts “1” from the registered fingerprint number n (step S506), returns to the step S502, and determines whether the registered fingerprint number n is greater than “0” again. In a case where the registered fingerprint number n is “0” or less (step S502: No), the controller 101 finishes the registration processing of a fingerprint, and shifts to the fingerprint operable state S1.

In the first embodiment, the registration processing of a fingerprint and setting processing of a corresponding function corresponding to a fingerprint subjected to execution of the registration processing are conducted in the wearable terminal 1. However, the first embodiment is not limited to this. The registration processing of a fingerprint and setting processing of a corresponding function corresponding to a fingerprint subjected to execution of the registration processing may be conducted in an external device such as a smart phone.

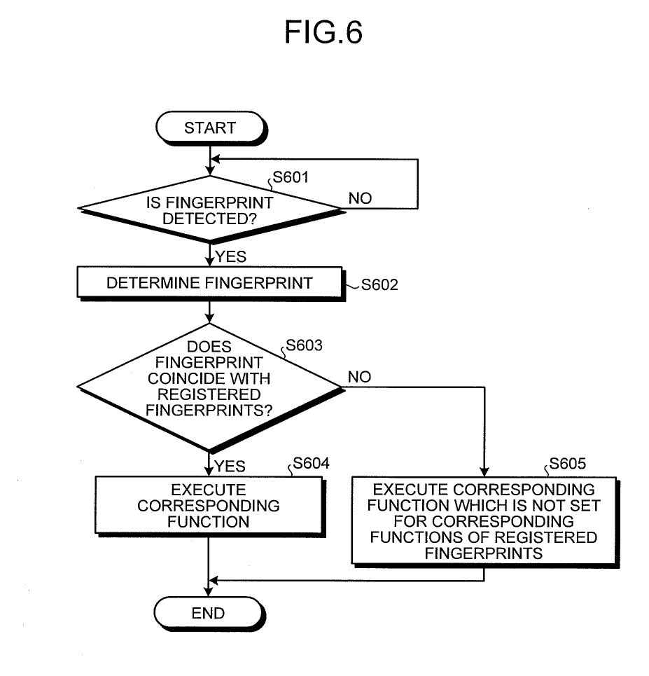

A flow of execution processing of a corresponding function conducted by the wearable terminal 1 according to the present embodiment will now be described with reference to FIG. 6. FIG. 6 is a flow chart illustrating a flow of execution processing of a corresponding function conducted by the wearable terminal according to the first embodiment.

If in a state in which a fingerprint is already registered, the operation button 14 is operated to turn on the power supply of the wearable terminal 1, and authentication processing of the user has succeeded, the controller 101 shifts to the fingerprint operable state S1.

In a case where a shift to the fingerprint operable state S1 is conducted (in other words, in a case where the authentication processing of the user has succeeded), in the first embodiment, the controller 101 executes a predetermined function prior to execution of a corresponding function (the first function or the second function) corresponding to a fingerprint that coincides with a fingerprint newly detected by the fingerprint sensor 13 among a plurality of fingerprints subjected to execution of the registration processing. Alternatively, the controller 101 executes a function executed lastly when a shift to the fingerprint operable state S1 is conducted last time. Alternatively, the controller 101 executes a corresponding function corresponding to a fingerprint that coincides with a fingerprint detected by the fingerprint sensor 13 and used in the authentication processing of the user among a plurality of fingerprints subjected to execution of registration processing. In a case where the authentication of the user has succeeded, therefore, it is possible to cause the corresponding function to be executed without causing the fingerprint sensor 13 to detect a fingerprint again. As a result, convenience of the wearable terminal 1 can be improved. Furthermore, in a case where a shift to the fingerprint operable state S1 is conducted, the controller 101 may cause the display screen 11 to display a predetermined screen (such as, for example, an image of U1). Alternatively, in a case where a shift to the fingerprint operable state S1 is conducted, the controller 101 may cause the display screen 11 to display a screen displayed lastly when a shift to the fingerprint operable state S1 is conducted last time. Or, in a case where a shift to the fingerprint operable state S1 is conducted, the controller 101 may cause the display screen 11 to display a screen concerning a corresponding function corresponding to a fingerprint that coincides with a fingerprint detected by the fingerprint sensor 13 and used in the authentication processing of the user.

Thereafter, the controller 101 waits for new detection of a fingerprint conducted by the fingerprint sensor 13 (step S601). If a fingerprint is detected by the fingerprint sensor 13 (step S601: Yes), the controller 101 determines whether the detected fingerprint coincides with one of a plurality of fingerprints subjected to execution of the registration processing (step S602).

In a case where the detected fingerprint coincides with one of a plurality of fingerprints subjected to execution of the registration processing (step S603: Yes), the controller 101 executes a corresponding function corresponding to a fingerprint that coincides with the fingerprint detected by the fingerprint sensor 13 among a plurality of fingerprints subjected to execution of the registration processing (step S604). With respect to a fingerprint is detected by the fingerprint sensor 13 until non-operation time out is caused, the controller 101 repeats execution of a corresponding function corresponding to a fingerprint that coincides with the detected fingerprint among a plurality of fingerprints subjected to execution of the registration processing.

Specifically, in a case where the fingerprint detected by the fingerprint sensor 13 coincides with one fingerprint comprised in a plurality of fingerprints subjected to execution of the registration processing, the controller 101 reads out function information stored to be associated with a fingerprint that coincides with the fingerprint detected by the fingerprint sensor 13 among the fingerprints subjected to execution of the registration processing, from the storage module 102. Then, the controller 101 executes a corresponding function indicated by the function information read out. In other words, the controller 101 executes a different corresponding function for every fingerprint detected by the fingerprint sensor 13. As a result, the fingerprint sensor 13 added as the personal authentication function can be used as means to order execution of a function the wearable terminal 1 comprises. Accordingly, the size and weight of the wearable terminal 1 comprising the fingerprint sensor 13 can be reduced.

On the other hand, in a case where the controller 101 has determined that the fingerprint detected by the fingerprint sensor 13 does not coincide with any of fingerprints subjected to execution of the registration processing (step S603: No), the controller 101 inhibits execution of a corresponding function corresponding to a fingerprint subjected to execution of the registration processing, and executes a preset function (step S605). For example, the controller 101 executes a function that is other than corresponding functions corresponding to fingerprints subjected to execution of the registration processing among a plurality of functions which can be executed in the wearable terminal 1. In a case where authentication processing of the user has failed, therefore, only the preset function is executed. As a result, security property of the wearable terminal 1 can be improved.

In the wearable terminal 1 according to the first embodiment, the fingerprint sensor 13 added as the personal authentication function can be used as means to order execution of a function the wearable terminal 1 has, in this way. Accordingly, the size and weight of the wearable terminal 1 comprising the fingerprint sensor 13 can be reduced.

Furthermore, the controller 101 sets the same corresponding function for fingerprints of fingers of the same kind (for example, a fingerprint of a forefinger of a right hand and a fingerprint of a forefinger of a left hand) among a plurality of fingerprints previously registered. Even in a case where a first finger (for example, the forefinger of the right hand) comprised in fingers of the same kind cannot be brought into contact with the fingerprint sensor 13 (for example, in a case where the wearable terminal 1 is worn on the right hand), therefore, it is possible to cause a corresponding function corresponding to the fingerprint of the first finger to be executed by bringing a second finger (for example, the forefinger of the left hand) into contact with the fingerprint sensor 13. As a result, it is possible to improve the convenience of the wearable terminal 1 at the time when causing a corresponding function to be executed by utilizing the fingerprint sensor 13.

### Second Embodiment

A second embodiment is an example in which registration processing of fingerprints corresponding to the registered fingerprint number is executed and then corresponding functions are set for fingerprints subjected to execution of the registration processing. In ensuing description, description will be omitted with respect to portions similar to those in the first embodiment.

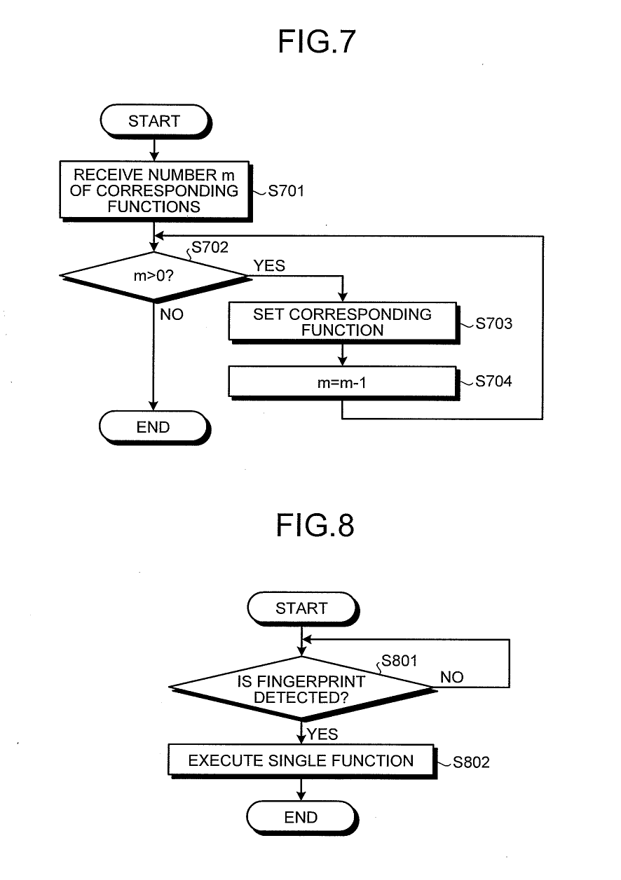

FIG. 7 is a flowchart illustrating a flow of setting processing of a corresponding function conducted by a wearable terminal according to the second embodiment. In the second embodiment, the controller 101 executes registration processing of fingerprints corresponding to the registered fingerprint number n and then receives a corresponding function number m transmitted from an external device such as a smart phone, via the communication module 104 (step S701). Here, the corresponding function number m is a number of corresponding functions that are set for fingerprints subjected to execution of the registration processing. The corresponding function number m is a number that is equal to the registered fingerprint number n or less.

With respect to finishing setting of a corresponding function for one fingerprint subjected to execution of the registration processing, the controller 101 determines whether the corresponding function number m is greater than “0” (step S702). In a case where the corresponding function number m is greater than “0” (step S702: Yes), the controller 101 sets a corresponding function for a fingerprint that is not subjected to setting of a corresponding function among a plurality of fingerprints subjected to execution of registration processing (step S703). At that time, the controller 101 sets a different corresponding function for each of the plurality of fingerprints subjected to execution of the registration processing.

In the second embodiment, for example, the controller 101 sets corresponding functions in an ascending order of the order in which each of corresponding functions is set in advance, as a corresponding function of the fingerprint subjected to execution of the registration processing as well as the first embodiment. Alternatively, the controller 101 may cause the display screen 11 (or a display module comprised in an external device such as a smart phone) to display a selection image to conduct selection from a plurality of corresponding functions and set a corresponding function selected by using the selection image, as a corresponding function for a fingerprint subjected to execution of the registration processing. At that time, the controller 101 inhibits selection of corresponding functions already set for fingerprints subjected to execution of the registration processing among the plurality of corresponding functions. As a result, it becomes possible for the controller 101 to set different corresponding functions respectively for fingerprints subjected to execution of the registration processing.

With respect to setting a corresponding function for one fingerprint subjected to execution of the registration processing, the controller 101 subtracts “1” from the corresponding function number m (step S704), returns to the step S702, and determines whether the corresponding function number m is greater than “0.” In a case where the corresponding function number m is “0” or less (step S702: No), the controller 101 finishes the setting of the corresponding function, and shifts to the fingerprint operable state S1.

In the wearable terminal 1 according to the second embodiment, setting of corresponding functions respectively for the plurality of fingerprints subjected to execution of the registration processing can be conducted collectively in this way. As a result, the setting work of a corresponding function can be conducted efficiently.

### Third Embodiment

A third embodiment is an execution example of a function of the wearable terminal 1 responsive to detection of a fingerprint conducted by the fingerprint sensor in a case where the authentication processing of the user using a fingerprint detected by the fingerprint sensor is not executed. In ensuing description, description will be omitted with respect to portions similar to those in the first embodiment.

FIG. 8 is a flow chart illustrating a flow of execution processing of a function conducted by the wearable terminal according to the third embodiment. In the case where the authentication processing of the user is not executed in the third embodiment, the controller 101 immediately shifts to the fingerprint operable state S1 when the operation button 14 is operated and the power supply of the wearable terminal 1 is turned on, and the controller 101 waits for detection of a fingerprint conducted by the fingerprint sensor 13 (step S801). If a fingerprint is detected by the fingerprint sensor 13 thereafter (step S801: Yes), the controller 101 executes a preset function (such as, for example, a single function other than corresponding functions corresponding to a plurality of fingerprints subjected to execution of the registration processing) among a plurality of functions the wearable terminal 1 has (step S802).

In the wearable terminal 1 according to the third embodiment, only a preset function is executed in this way in the case where the authentication processing of the user using a fingerprint detected by the fingerprint sensor 13 is not executed. As a result, the security property of the wearable terminal 1 can be improved.

According to the first to third embodiments, the size and weight of the wearable terminal 1 comprising the fingerprint sensor 13 can be reduced as described heretofore.

By the way, a program executed in the wearable terminal 1 according to the embodiments is previously incorporated in a ROM or the like and provided. However, the program is not limited to this. The program may be recorded on a recording medium which can be read by a computer such as a CD-ROM, a flexible disk (FD), a CD-R, or a DVD (Digital Versatile Disk) as a file having a form that can be installed or a form that can be executed, and provided.

In addition, the program to be executed by the wearable terminal 1 according to the embodiments may be stored on a computer connected to a network such as the Internet, downloaded via the network, and provided. Furthermore, the program to be executed by the wearable terminal 1 according to the embodiments may be provided or distributed via a network such as the Internet.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a fingerprint detector; and
circuitry configured to execute a first function when a detected fingerprint substantially coincides with a first fingerprint from a plurality of registered fingerprints of a user, and to execute a second function different from the first function when a detected fingerprint substantially coincides with a second fingerprint different from the first fingerprint from a plurality of registered fingerprints of the user.

2. The electronic device according to claim 1, wherein
the circuitry is further configured to execute authentication based on a detected fingerprint, wherein the circuitry is further configured to execute:
the first function when a detected fingerprint substantially coincides with the first fingerprint and the authentication of the user succeeds;
the second function when a detected fingerprint substantially coincides with the second fingerprint and the authentication succeeds; and
restriction of at least one of the first function and the second function when the authentication fails or is not executed.

3. The electronic device according to claim 2, wherein the circuitry is further configured to execute a third function, prior to the execution of the first function or the second function respectively when the authentication succeeds.

4. The electronic device according to claims 1, wherein the circuitry is further configured to preset a distinct function to each of the plurality of registered functions corresponding to the plurality of registered fingerprints.

5. The electronic device according to claims 1, wherein the circuitry is further configured to execute a preset function when a detected fingerprint does not coincide with any of the plurality of registered fingerprints.

6. A method executed in an electronic device comprising:
detecting a fingerprint by a detector,
executing a first function when a detected fingerprint substantially coincides with a first fingerprint from a plurality of registered fingerprints of a user; and
executing a second function different from the first function when a detected fingerprint substantially coincides with a second fingerprint different from the first fingerprint from a plurality of registered fingerprints of the user.

7. The method according to claim 6, further comprising:
executing authentication based on a detected fingerprint;
executing the first function when a detected fingerprint substantially coincides with the first fingerprint and the authentication of the user succeeds;
executing the second function when a detected fingerprint substantially coincides with the second fingerprint and the authentication succeeds; and
restricting execution of at least one of the first function and the second function when the authentication failed or is not executed.

8. The method according to claim 7, further executing a third function, prior to the execution of the first function or the second function respectively when the authentication succeeds.

9. The method according to claims 6, wherein presetting a distinct function to each of the plurality of registered functions corresponding to the plurality of registered fingerprints.

10. The method according to claims 6, further executing a preset function when a detected fingerprint does not coincide with any of the plurality of registered fingerprints.

11. A computer program product having a non-transitory computer readable medium including programmed instructions for controlling an electronic device capable to detect a fingerprint, wherein the instructions, when executed by a computer, cause the computer to execute:
a first function when a detected fingerprint substantially coincides with a first fingerprint from a plurality of registered fingerprints of a user; and
a second function different from the first function when a detected fingerprint substantially coincides with a second fingerprint different from the first fingerprint from a plurality of registered fingerprints of the user.

12. The computer program product according to claim 11, wherein the instructions further cause the computer to execute:
authentication based on a detected fingerprint;
the first function when a detected fingerprint substantially coincides with the first fingerprints and the authentication of the user succeeds;
the second function when a detected fingerprint substantially coincides with the second fingerprint and the authentication succeeds; and
restriction of at least one of the first function and the second function when the authentication fails or is not executed.

13. The computer program product according to claim 12, wherein the instructions further cause the computer to execute a third function, prior to the execution of the first function or the second function respectively when the authentication succeeds.

14. The computer program product according to claims 11, wherein the instructions further cause the computer to execute to preset a distinct function to each of the plurality of registered functions corresponding to the plurality of registered fingerprints.

15. The computer program product according to claims 11, wherein the instructions further cause the computer to execute a preset function when a detected fingerprint does not coincide with any of the plurality of registered fingerprints.
